(19) United States
(12) Patent Application Publication
(10) Pub. No.: US 2011/0184100 A1
(43) Pub. Date: Jul. 28, 2011

(54) SOFT, PELLETIZED POLY(VINYL CHLORIDE) PLASTISOL

(75) Inventor: Stephen D. Horton, Avon, OH (US)

(73) Assignee: POLYONE CORPORATION, Avon Lake, OH (US)

(21) Appl. No.: 13/063,452

(22) PCT Filed: Sep. 8, 2009
(86) PCT No.: PCT/US2009/056155

§ 371 Date: Mar. 10, 2011

Related U.S. Application Data
(60) Provisional application No. 61/095,699, filed on Sep. 10, 2008.

(51) Int. Cl. C08L 27/06; C08K 5/521; C08K 5/11; C08K 5/103; C08K 5/1515; B29C 47/78; B29C 47/00

(52) U.S. Cl. 524/109; 524/569; 524/147; 524/314; 524/311; 524/318; 524/310; 524/313; 264/176.1; 264/148

(57) ABSTRACT

A soft, pelletizable poly(vinyl chloride) plastisol having a Shore A hardness of less than about 70 is disclosed. The plasticizers employed in the plastisol can be petroleum-based plasticizers or bioplasticizers or both. A method of gelation, fusion, and controlled cooling in an agitating chamber permits a conventional liquid plastisol to be transformed into the pelletizable plastisol strand. If a pelletizer is used after cooling into strands or other shapes, then pelletized plastisol results. The formulation of liquid plastisol for hardness is unaffected by the transformation. The solidified plastisol can be stored for later extrusion or molding into a final plastic article shape.

### CLAIM OF PRIORITY

This application claims priority from U.S. Provisional Patent Application Ser. No. 61/095,699 bearing Attorney Docket Number 12008020 and filed on Sep. 10, 2008, which is incorporated by reference.

### FIELD OF THE INVENTION

This invention relates to plastisols that are soft and solid enough to be made into the form of pellets.

### BACKGROUND OF THE INVENTION

Industrial and commercial products are often made from poly(vinyl chloride) (“PVC”) compounds in the form either of viscous liquids of unfused PVC (such as plastisols) or flexible PVC solids (such as pellets, particles, or cubes).

Along the Shore A scale of hardness, flexible PVC solids are very difficult to prepare with a Shore A hardness of less than about 70. Unfused PVC plastisols have no effective hardness until they are fused because they are liquids.

### SUMMARY OF THE INVENTION

What the art needs is a method of making a flexible PVC solid pellet having a Shore A hardness of less than about 70 and preferably less than about 50, and more preferably at any hardness within a range of about 10 to about 50 and even more preferably at any hardness within a range of about 20 to about 45.

The art also needs a pelletizable plastisol to facilitate subsequent molding or extruding efficiency arising from the solid form of the plastisol.

The present invention solves both of these problems by controlling the melt agitation of the plastisol in an agitating chamber, such as an extruder, in such a manner that a pelletizable plastisol results.

For purposes of this invention, “pelletizable plastisol” means a liquid plastisol which has undergone one heat history in an agitating chamber having conditions which permit gelation, fusion, and cooling, in that order, to allow the plastisol to solidify, for later pelletizing, if desired. The solidified plastisol that is pelletized later becomes a “pelletized plastisol.”

The pelletizable plastisol has all of the starting properties of a conventional, commercial plastisol and results in a gelled, fused plastisol which can be formed into a final plastic article via later molding or extruding. So does the pelletized plastisol. The difference in the intermediate products of this invention is their operational form, strands vs. pellets. Pellets are preferred, but strands are also useful.

The method of the present invention is not a chemical reaction but a physical transformation from particulate PVC in plasticizer to a fused, solid solution of plasticizer and PVC particles of pelletizable shape.

As a function of the transformation process, the plastisol retains its very low hardness, in the Shore A ranges described above. If that starting liquid plastisol were to be interrupted during a manufacturing operation of molding or extruding at that moment when the plastisol has fused, the method of the present invention provides a means of suspending that manufacturing operation, such that the conventional plastisol is part way done in its transformation into a final article.

Pelletizable and pelletized plastisol therefore become intermediate products of immense and versatile value, because the solid nature of the strands or pellets, very soft in hardness, then become an item of inventory which can be prepared at one time, stored for an interval of controlled duration, and then used to complete the formation of the final article.

Storage, transport, and usage of a solid often has advantages over storage, transport, and usage of a liquid. For those circumstances in the situation of flexible PVC compounds, particularly those needing a Shore A hardness of less than 70 or even 50, the pelletizable and pelletized plastisols made by the methods of the present invention are unexpectedly new starting materials for the person skilled in plastics molding or extruding operations. Because of the handling properties of a solid, the plastisol offers processing efficiency to that person.

One aspect of the present invention is a pelletizable plastisol comprising polyvinyl chloride and having a Shore A hardness of less than about 70.

Another aspect of the present invention is a method of making a pelletizable plastisol, comprising the steps of (a) introducing liquid plastisol into a heated agitating chamber, (b) gelling the plastisol, (c) fusing the plastisol, (d) cooling the plastisol within the agitating chamber sufficiently to form a solidifying pelletizable plastisol strand. Preferably, the method includes (e) cooling the solidifying strand outside of the agitating chamber, and (f) dividing the solid strand into smaller pieces to make a pelletized plastisol, optionally using a water trough followed by a rotary blade strand pelletizer. Alternatively, one can replace both the trough and the strand pelletizer with an underwater pelletizer.

Another aspect of the invention is a pelletized plastisol made from the pelletizable plastisol strand by steps (e) and (f) above.

Features and advantages of the invention will be explained in respect of the various embodiments with reference to the following drawing.

### BRIEF DESCRIPTION OF THE DRAWING

FIG. 1 is a side view of a typical agitating chamber for transforming the liquid plastisol into the pelletizable plastisol.

### EMBODIMENTS OF THE INVENTION

Agitating Chamber

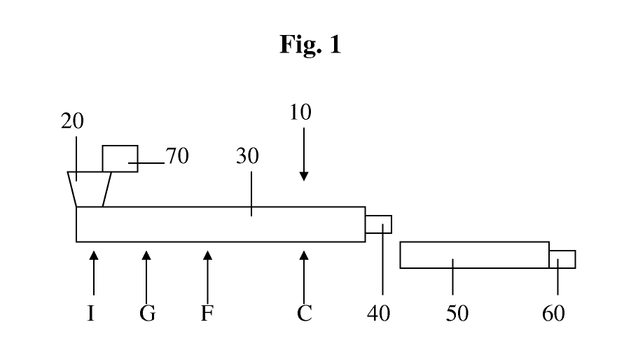

FIG. 1 shows a typical agitating chamber 10 having an inlet 20, a heated section 30, and an outlet 40. While chamber 10 looks mostly like an extruder, indeed, any batch or continuous melt-agitating equipment can be employed in the invention, if temperature variation can be arranged in a specific order.

An extruder is preferred because it is continuous in operation with heating zones within section 30 which can be controlled according to requirements of the method of the invention. The extruder can be a single screw, a co-rotating twin screw, or a counter-rotating twin screw extruder of conventional length/diameter ratio.

In agitating chamber 10, heated section 30 has four different segments I, G, F, and C between inlet 20 and outlet 40.

Segment I is an introduction zone contiguous to inlet 20 and for which the liquid plastisol can begin being heated and agitated.

Segment G is a gelation zone contiguous to Segment I wherein the liquid plastisol undergoes gelation.

Segment F is a fusion zone contiguous to Segment G wherein the gelled plastisol fuses with sufficient shearing action to produce a homogeneous polymer melt. It should be noted that fusion in some formulations may commence so rapidly after gelation that it is not possible to identify where gelation zone Segment G ends and fusion zone Segment F commences. But it is true, regardless of the length and possible overlap of Segments G and F, that gelation of polymer precedes fusion at the macromolecular level.

Segment C is a cooling zone contiguous to Segment F wherein the fused plastisol begins to cool, preferably at a controlled rate, from its fusion temperature to a temperature at which the fused plastisol becomes semi-solid enough for stranding through exit at outlet 40.

The outlet 40 can be a single strand die, a multi-strand die, or any other conventional outlet from an agitating chamber to form a profile shape for plastic products.

The method of the present invention, when considering applicability to an extruder, employs Segments I, G, F, and C in that order, because, unexpectedly, it has been found possible to bring the liquid plastisol to gelation and fusion before cooling, preferably in a controlled manner over the remaining portion of heated section 30. The goal of Segment C is to lower the temperature of the fused plastisol sufficiently that it has begun to solidify enough that a strand of solid plastisol can emerge at outlet 40 to be cut into smaller pieces, such as pellets when the profile of the outlet die is circular.

Table 1 shows the range of percentages of heated section 30 for each of the Segments and the ranges of temperatures suitable and preferred for each of the Segments, including the outlet 40.

TABLE 1

| | Segment | Segment | Segment | Segment | | |
|---|---|---|---|---|---|---|
| | I | G | F | C | | Die |
| | % of Heated Section | | | | | |
| | First | Next | Next | Next 40-70% | | Final |
| | 10-30% | 5-10% | 5-20% | C Start | C End | 5-10% |
| Acceptable | 145-185° C. | 145-180° C. | 145-180° C. | 145-180° C. | 100-120° C. | 100-125° C. |
| Temperature | | | | | | |
| Desired | 155-180° C. | 155-170° C. | 155-170° C. | 155-170° C. | 100-120° C. | 100-120° C. |
| Temperature | | | | | | |
| Preferred | 158-167° C. | 158-162° C. | 158-162° C. | 158-162° C. | 106-117° C. | 100-110° C. |
| Temperature | | | | | | |

The temperature for each of Segments I, G, and F can be the same or similar in order to provide a constant energy introduced over time into the plastisol during its transformation. Therefore, the quantum of energy added can be computed from the temperature, agitation, and dwell time of these three Segments.

Segment C is preferably divided into sub-zones in which the temperature decreases from the C Start temperature shown in Table 1 to the C End temperature in Table 1. Depending on the length of heated section 30 devoted to the cooling step, the ramp-down of temperature can be more or less gradual and can be controlled to provide a curvature of rate ranging from straight-line to asymptotic. Because the cooling step is critical to the ability to emit a strandable semi-solid, a decrease in temperature of slightly curving slope is preferred from the beginning of Segment C to the end of Segment C.

Agitation or stirring or other mechanical action can occur in each of the Segments of heated section 30. If in a mixer or an extruder, the impeller or screw can rotate at a range from about 25 to about 500, and preferably from about 75 to about 250 rpm.

The strands of solidifying plastisol can then be air-cooled or water-cooled. Air-cooled depends on the ambient temperature, whereas water-cooled can be temperature controlled. For that reason, the latter is preferred.

FIG. 1 also shows a water trough 50 into which the stranded, solidifying plastisol is placed and a pelletizer 60 which is used after suitable cooling and solidification to form the pelletizable plastisol strand(s) into pellets.

Alternatively, an underwater pelletizer can be used which is mounted to the end of the agitating chamber such that the pelletizable strand is simultaneously cooled further and cut as it begins to emerge from the die. This alternative reduces the possibilities of a pelletizable plastisol intermediate product in favor of a pelletized plastisol intermediate product.

It should be noted the profile of the outlet 40 creates the cross-section geometry of the strand(s), and their subsequent optional cutting results in a shape which can be cylindrical, cubic, star-shaped rods, or another solid geometry selection. For purposes of this invention all possible shapes are denominated as “pellets”.

The temperature of the optional water trough 50 can range from about 1° C. to about 27° C., and preferably from about 4° C. to about 10° C., to assure that pelletizer 60 makes a clean cut of the moving strand, now fully solidified but extremely soft, to form each pellet.

Finally, it is optional, but preferred to provide a metering device 70 upstream of inlet 20 to control the amount of liquid plastisol entering the agitating chamber 10. The metering device can range from a valve-controlled, gravity feed reservoir in simplicity to a peristaltic pump in complexity. Also, it is helpful to have the feed rate into the chamber 10 be approximately the same as the pelletization rate of the pelletizer 60, if that optional equipment is used. Because even when fully solid, the plastisol is very soft, thereby causing the linear tension on the stranded semi-solid emerging from outlet 40 to be taken into consideration when establishing line speed and throughput efficiency.

Plastisol

Any currently available plastisol and any future-developed liquid plastisol is a candidate for use in the present invention.

The polymer processing art is quite familiar with vinyl plastisols. These plastisols are formed from dispersion-, microsuspension-, and emulsion-grade poly(vinyl chloride) (PVC) resins (homopolymers and copolymers) and plasticizers. Exemplary dispersion-grade PVC resins are disclosed in U.S. Pat. Nos. 4,581,413; 4,693,800; 4,939,212; and 5,290,890, among many others such as those referenced in the above four patents.

The primary liquid plasticizers used in preparing fluid plastisols from vinyl resins are organic esters of various acids such as phthalic, phosphoric, adipic, sebacic, citric, unsaturated fatty acids, and the like. Of these, the phthalate esters are most frequently used as principal plasticizers for vinyl chloride resins. Dialkyl phthalates containing medium length alkyl groups (e.g. from about 6 to about 12 carbon atoms in length) provide a good balance of plastisol properties when used in proportions from about 30 to about 300 parts by weight per 100 parts of the spray dried vinyl chloride resin powder. Specific examples of useful liquid plasticizers include dioctyl phthalate (DOP), butyl benzyl phthalate (BBP), dioctyl adipate, dibutyl sebacate, diisononyl phthalate (DINP), hydrogenated diisononyl phthalate (DINCH), hydrogenated di-2-ethylhexyl phthalate, glyceryl stearates, and combinations thereof.

Organic esters of unsaturated fatty acids are an excellent alternative to phthalate plasticizers because they are prepared from biologically renewable resources. U.S. Pat. No. 6,797,753 (Benecke et al.), incorporated by reference herein, discloses plasticizing polyvinyl chloride polymers where the plasticizers contain fatty acids derived from vegetable oils and the fatty acids are substantially fully esterified with an alcohol (monool or polyol), the fatty acids having unsaturated bonds that are substantially fully epoxidized, and wherein the fatty acids are added substantially randomly to one or more hydroxyl sites on the alcohol. The plasticizers may be added in amounts between about 10 to 230 phr of PVC resin. These “epoxidized soyate” plasticizers derived from vegetable oil disclosed in Benecke et al., such as epoxidized pentaerythritol tetrasoyate, epoxidized propylene glycol disoyate, epoxidized ethylene glycol disoyate, epoxidized methyl soyate, and epoxidized sucrose octasoyate, are among a group of plasticizers commonly called “bioplasticizers” and are very suitable for use in the present invention.

PolyOne Corporation (www.polyone.com) is a commercial source of liquid PVC plastisols for every consumer market. These dispersions of PVC resins in plasticizing liquids are enhanced by the addition of heat or light stabilizers, color pigments, flame retardants, blowing agents and other additives required for the intended product.

Preferred commercially available PVC plastisols include Geon™ MB2536 Flesh and MB2536A plastisol made with Geon™ 121A dispersion grade PVC.

Optional Additives

A variety of ingredients commonly used in the thermoplastics industry can also be included in the product of the present invention. Non-limiting examples of such optional additives include slip agents, antiblocking agents, antioxidants, ultraviolet light stabilizers, quenchers, plasticizers, mold release agents, lubricants, antistatic agents, fire retardants, and fillers such as glass fibers, talc, chalk, or clay, and combinations of them. Such optional additives can be included in the mixture of the present invention in an amount from none at all to about 150 phr, and preferably from about 0 to about 100 parts per hundred of PVC resin.

Any conventional colorant useful in coatings and paints is also acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others. The amount of colorant can range from none at all to about 5, and preferably from about 0 to about 3 parts per hundred of the PVC resin.

Storage

Pelletizable plastisols, particularly those which have been pelletized, can be stored in the same or similar manner as any other solid thermoplastic ingredient for later molding or extruding into the shape of the final plastic article.

Unexpectedly, the stored product of this invention has the properties of the liquid plastisol from whence it came, but in the form of a PVC solid, very soft compound. In other words, a PVC solid of previously unattainably low Shore A hardness has been made.

### Usefulness of the Invention

The stored pelletizable plastisol strands or pelletized plastisol pellets can be used in subsequent molding or extruding operations of all types currently available to PVC compounding, limited only by the imagination of the operator of the molding or extruding machine.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

Plastisols of this invention can be certified for end-use automotive, FDA, UL, ASTM, NSF, USDA, military, medical or customer-specific applications.

Further embodiments are described in the following examples.

### EXAMPLES

Table 2 shows the melt-agitating conditions for two commercially available liquid plastisol products from PolyOne Corporation: MB2536 Flesh and MB2536A Flesh to form pelletizable plastisol strands in a Leistritz 27 mm twin-screw extruder having nine heating zones and a heated stranding die outlet, associated water bath trough, and to form pelletized plastisol immediately thereafter using a Conair brand Model No. 304 rotary blade strand pelletizer. A valve-controlled, gravity feed reservoir was used as the metered feeder. The MB2536 Flesh liquid plastisol is formulated to result commercially in a fused molded solid of approximately 40 Shore A Hardness. The MB2536A Flesh liquid plastisol is formulated to result commercially in a fused molded solid of approximately 30 Shore A Hardness. Pellets of approximately 0.5 cm length×0.4 cm diameter were formed.

TABLE 2

| | Example 1 | Example 2 |
|---|---|---|
| Hardness | 30 Shore A | 40 Shore A |

| Segment | Zone | Set-Pt. (° C.) | Set-Pt. (° C.) |
|---|---|---|---|
| I | 1 | 165.6 | 165.6 |
| I | 2 | 165.6 | 165.6 |
| I | 3 | 165.6 | 165.6 |
| G | 4 | 160.0 | 160.0 |
| F | 5 | 160.0 | 160.0 |
| C | 6 | 148.9 | 154.4 |
| C | 7 | 126.7 | 135.0 |
| C | 8 | 115.6 | 121.1 |
| C | 9 | 107.2 | 112.8 |
| Die | Die | 104.4 | 107.2 |

| | | |
|---|---|---|
| Metering Rate (lbs/hr) | 25 | 25 |
| (kg/hr) | 11.3 | 11.3 |
| Screw Speed (rpm) | 150 | 150.0 |
| Torque (%) | 13 | 14 |
| Die Pressure (psi) | 360 | 360 |
| (kPa) | 2482 | 2482 |
| Melt Temp (° C.) | 108 | 113 |
| Water Trough Temp (° C.) | <10 | <10 |
| Pelletizer Speed | 6.60 | 7.60 |
| (scale of 0-10) | | |

Pelletizable plastisol was stranded from the die into the water bath trough. Pelletized plastisol was made from the strands by the pelletizer at the speed indicated above, which very closely approximated the rate of output of pelletizable plastisol strands from a metering rate of 25 pounds/hr (11.3 kg/hr) at the throat of the extruder.

Key to the successful pelletizing of both plastisols were the careful metering of plastisol into the extruder, control of heat in each of the zones constituting Segments I, G, F, and C, the low temperature of the water bath trough, and a pelletization rate that closely matched the metering rate, all operating at a screw speed of around 150 rpm.

By comparison, a previous experiment with a screw speed of 300 rpm did not yield acceptable pelletizable plastisol for a number of reasons. The screw speed of 300 rpm was too fast; no cooling Segment C was used—the temperature of Segment F was maintained to the die; and there was a mismatch of metering rate and pelletizing rate causing internal tension on the strands. The results were completely unusable and no steady-state, continuous production was achievable for more than a few minutes.

The invention is not limited to these embodiments. The claims follow.

What is claimed is:

1. A pelletizable plastisol comprising polyvinyl chloride and having a Shore A hardness of less than about 70.

2. The plastisol of claim 1, wherein the plastisol is divided into the form of pellets.

3. The plastisol of claim 1, wherein the polyvinyl chloride is a homopolymer or copolymer resin.

4. The plastisol of any of claim 1, wherein the plasticizer is an organic ester of phthalic acid, phosphoric acid, adipic acid, sebacic acid, citric acid, unsaturated fatty acids, or combinations of them.

5. The plastisol of claim 3, wherein the plasticizer is present in an amount of about 30 to about 300 parts by weight per 100 parts of polyvinyl chloride resin.

6. The plastisol of claim 4, wherein the plasticizer is selected from the group consisting of dioctyl phthalate, butyl benzyl phthalate, dioctyl adipate, dibutyl sebacate, dinonyl phthalate, hydrogenated diisononyl phthalate, hydrogenated di-2-ethylhexyl phthalate, glyceryl stearates, epoxidized soyates, and combinations thereof.

7. The plastisol of claim 1 wherein the plastisol is a polyvinyl chloride compound further comprising slip agents, antiblocking agents, antioxidants, light stabilizers, heat stabilizers, flame retardants, blowing agents, colorants, quenchers, secondary plasticizers, mold release agents, lubricants, antistatic agents, fire retardants, fillers, or combinations of them.

8. A method of making the pelletizable plastisol of claim 1, comprising the steps of:
(a) introducing liquid plastisol into a heated agitating chamber,
(b) gelling the plastisol,
(c) fusing the plastisol, and
(d) cooling the plastisol within the agitating chamber sufficiently to form a solidifying pelletizable plastisol strand.

9. The method of claim 8, wherein the agitating chamber is an extruder.

10. The method of claim 8, further comprising the steps of:
(e) cooling the solidifying strand outside of the agitating chamber, and
(f) dividing the solid strand into smaller pieces to make a pelletized plastisol.

11. The method of claim 10, wherein the cooling step is done in water trough and the dividing step is done by a pelletizer.

12. The method of claim 11, wherein the pelletizer is an underwater pelletizer.

13. A pelletized plastisol made from the method of claim 9.

14. The pelletized plastisol of claim 13, wherein the Shore A hardness ranges from about 10 to about 50.

15. A plastic article molded or extruded from the pelletized plastisol of claim 2, wherein the Shore A hardness ranges from about 10 to about 50.

16. The plastisol of claim 2, wherein the polyvinyl chloride is a homopolymer or copolymer resin, and wherein the plasticizer is an organic ester of phthalic acid, phosphoric acid, adipic acid, sebacic acid, citric acid, unsaturated fatty acids, or combinations of them.

17. The plastisol of claim 16, wherein the plasticizer is present in an amount of about 30 to about 300 parts by weight per 100 parts of polyvinyl chloride resin; wherein the plasticizer is selected from the group consisting of dioctyl phthalate, butyl benzyl phthalate, dioctyl adipate, dibutyl sebacate, dinonyl phthalate, hydrogenated diisononyl phthalate, hydrogenated di-2-ethylhexyl phthalate, glyceryl stearates, epoxidized soyates, and combinations thereof; and wherein the plastisol is a polyvinyl chloride compound further comprising slip agents, antiblocking agents, antioxidants, light stabilizers, heat stabilizers, flame retardants, blowing agents, colorants, quenchers, secondary plasticizers, mold release agents, lubricants, antistatic agents, fire retardants, fillers, or combinations of them.

18. The pelletized plastisol of claim 13, wherein the polyvinyl chloride is a homopolymer or copolymer resin; and wherein the plasticizer is an organic ester of phthalic acid, phosphoric acid, adipic acid, sebacic acid, citric acid, unsaturated fatty acids, or combinations of them.

19. The pelletized plastisol of claim 18, wherein the plasticizer is present in an amount of about 30 to about 300 parts by weight per 100 parts of polyvinyl chloride resin; wherein the plasticizer is selected from the group consisting of dioctyl phthalate, butyl benzyl phthalate, dioctyl adipate, dibutyl sebacate, dinonyl phthalate, hydrogenated diisononyl phthalate, hydrogenated di-2-ethylhexyl phthalate, glyceryl stearates, epoxidized soyates, and combinations thereof; and wherein the plastisol is a polyvinyl chloride compound further comprising slip agents, antiblocking agents, antioxidants, light stabilizers, heat stabilizers, flame retardants, blowing agents, colorants, quenchers, secondary plasticizers, mold release agents, lubricants, antistatic agents, fire retardants, fillers, or combinations of them.

20. The plastic article of claim 15,
wherein the polyvinyl chloride is a homopolymer or copolymer resin;
wherein the plasticizer is an organic ester of phthalic acid, phosphoric acid, adipic acid, sebacic acid, citric acid, unsaturated fatty acids, or combinations of them;
wherein the plasticizer is present in an amount of about 30 to about 300 parts by weight per 100 parts of polyvinyl chloride resin;
and wherein the plastic article further comprises slip agents, antiblocking agents, antioxidants, light stabilizers, heat stabilizers, flame retardants, blowing agents, colorants, quenchers, secondary plasticizers, mold release agents, lubricants, antistatic agents, fire retardants, fillers, or combinations of them.
